(19) United States
(12) Patent Application Publication
(10) Pub. No.: US 2006/0045841 A1
(43) Pub. Date: Mar. 2, 2006

(54) Process for making titanium dioxide and resulting product

(76) Inventors: Daniel H. Craig, Edmond, OK (US); Jeffrey D. Elliott, Oklahoma City, OK (US); George A. Perakis, Edmond, OK (US); Harmon E. Ray, Yukon, OK (US)

Correspondence Address: William B. Miller, 123 Robert S. Kerr Avenue, Oklahoma City, OK, 73102, US

(21) Appl. No.: 10/928,387

(22) Filed: Aug. 30, 2004

(51) Int. Cl. C09C 1/36

(52) U.S. Cl. 423/610; 106/436

(57) ABSTRACT

A process is disclosed for making titanium dioxide pigment particularly suited for dispersion in thermoplastics, in which the titanium dioxide pigment is recoverable from a slurry through the use of conventional vacuum-type and/or pressure-type filtration systems without the deposition of additional inorganic oxides and in the absence of added flocculating agents, and further in which the thus-recovered, washed and filtered pigment can be dried by spray drying, without the dilution required in the production of such pigments according to a prior art process likewise omitting the deposition of additional inorganic oxides to those formed in a vapor phase oxidation step providing the agglomerated titanium dioxide starting material and omitting any use of added flocculating agents.

### FIELD OF THE INVENTION

This invention relates to an improved method of titanium dioxide pigment manufacture and to the titanium dioxide produced by the improved method. The pigments produced according to this method are useful in coatings and thermoplastics when formulated therein.

### BACKGROUND OF THE INVENTION

Titanium dioxide pigments are widely used as coloring agents in plastics, paints, inks, and paper, and are generally produced in two crystalline forms, anatase and rutile. Rutile titanium dioxide is commonly produced from titanium tetrachloride using vapor phase oxidation processes as disclosed in any number of patents and other printed publications, for example, in U.S. Pat. Nos. 3,208,866, 3,512,219, 5,840,112, 6,207,131 and 6,350,427. The reaction effluent from these vapor phase oxidation systems is generally cooled immediately upon leaving the reaction chamber, yielding a solid, agglomerated titanium dioxide intermediate.

This intermediate typically undergoes further processing steps in order to provide a finished product suitable for the uses listed above, including:
(1) dispersing the intermediate (or crude) material in an aqueous medium using a dispersing agent such as a polyphosphate,
(2) wet milling the resulting slurry to achieve a predetermined particle size,
(3) precipitating inorganic oxides such as silica or alumina onto the particle surfaces of the wet milled titanium dioxide slurry,
(4) recovering the alumina and/or silica treated titanium dioxide pigment from the aqueous slurry by filtration,
(5) washing the filtered product to remove salts and impurities,
(6) drying the washed filtered product, and
(7) dry-milling the dried pigment using a fluid energy mill.

The deposition of inorganic oxides onto the wet-milled titanium dioxide provides some desired end-use pigment properties and also enables the pigment to be recovered and washed using conventional vacuum-type and/or pressure-type filtration systems. Unfortunately, the added inorganic oxides can reduce the dispersibility of the dry pigment in thermoplastics, for instance, so that as an alternative to the added inorganic oxides, polymeric flocculants and/or multivalent metal ion flocculating salts have been added to the wet milled titanium dioxide dispersion in order to still enable the pigment to flocculate, be collected and recovered using conventional vacuum-type and/or pressure-type filtration systems.

However, the polymeric flocculants frequently themselves detract from the performance of the processed titanium dioxide product. To this end, commonly-assigned U.S. Pat. No. 5,332,433 (“the '433 patent”), the entire content of which is incorporated by reference, discloses a process for producing titanium dioxide which has substantially no added inorganic oxides and no added flocculating agents, but wherein the pigment is enabled to be recovered using conventional vacuum-type and/or pressure-type filtration systems. Details of the process comprise:
(a) forming a mixture comprising a titanium dioxide material in a liquid medium, said titanium dioxide material being an agglomerated titanium dioxide material which has been produced by a reaction process and wherein, other than any inorganic oxides formed in said reaction process along with said titanium dioxide material, substantially no inorganic oxides have been deposited on said titanium dioxide material;
(b) wet milling said agglomerated titanium dioxide material in said liquid medium;
(c) after step (b), reducing the pH of said mixture to a value not exceeding 4.0;
(d) after step (c), adding an effective amount of a base to said mixture to adjust the pH of said mixture to a value in the range of from about 5 to about 8, to cause said titanium dioxide material to flocculate;
(e) after step (d), removing said titanium dioxide material from said mixture; and
(f) after step (e), washing said titanium dioxide material,
wherein, other than any redeposited inorganic oxides originally formed in said reaction process along with said titanium dioxide material, substantially no inorganic oxides are deposited during said method on said titanium dioxide material.

However, when spray drying is used to dry the titanium dioxide material following step (f), the washed titanium dioxide material is typically diluted with additional carrier liquid to enable delivery of the titanium dioxide material slurry to the spray dryer system. This results in slower spray dryer through-put rates due to the presence of the additional carrier medium. In addition, the resulting pigments produced, while demonstrating improved properties over pigments of the prior art, typically manifest only limited melt flow or polymer processing enhancements when formulated into polyolefin thermoplastics, and in particular, polyolefin concentrates.

### SUMMARY OF THE PRESENT INVENTION

The present invention, in contrast, provides in one aspect an improved process for making titanium dioxide pigment in which the titanium dioxide pigment is recoverable from a slurry through the use of conventional vacuum-type and/or pressure-type filtration systems without the deposition of additional inorganic oxides and in the absence of added flocculating agents, and further in which the thus-recovered, washed and filtered pigment can be dried by spray drying without the dilution and reduced through-put rates associated with the prior, commonly-assigned '433 patent.

The improved process of the present invention broadly comprises:
(a) forming a mixture comprising a titanium dioxide material in water, said titanium dioxide material having been produced by a reaction process including a vapor phase oxidation step and wherein, other than any inorganic oxides formed in said reaction process along with said titanium dioxide material, substantially no inorganic oxides have been deposited on said titanium dioxide material;
(b) wet milling said mixture;
(c) after step (b), reducing the pH of said mixture to a value not exceeding 4.0;
(d) after step (c), adding an effective amount of a base to cause said titanium dioxide material to flocculate whereby the titanium dioxide material may be recovered by vacuum or pressure filtration;
(e) after step (d), removing said titanium dioxide material from said mixture by vacuum or pressure filtration;
(f) after step (e), washing said titanium dioxide material;
(g) after step (f), raising the pH of said washed titanium dioxide material to a value greater than about 8.5 through combination with an alkalinizing agent; and
(h) after step (g), spray drying a dispersion of the washed titanium dioxide to yield a dry titanium dioxide pigment powder.

The resulting product is optionally then post-processed in a fluid energy mill in the presence or absence of additional functional additives known to the art.

The step of increasing the pH of the washed titanium dioxide material according to the instant invention enables the spray drying process to be carried out at significantly higher spray dryer feed concentrations, resulting in higher product through-put rates. In addition, the improved procedure requires substantially less heat energy per unit of pigment, since less water is required to be removed from the higher solids feed, further lowering processing costs.

Surprisingly, when the pH of the titanium dioxide material is raised above about 8.5 with alkalinizing agents, improvements also accrue to the finished titanium dioxide pigment. For instance, titanium dioxide pigments produced according to the process of the instant invention exhibit improved dispersibility when formulated into polyolefin concentrates.

### DETAILED DESCRIPTION OF PREFERRED EMBODIMENTS

In general, any type of agglomerated titanium dioxide material can be processed in accordance with the instant invention. Preferred is rutile titanium dioxide material. Most preferred is rutile titanium dioxide which has been produced from titanium tetrachloride using a vapor phase oxidation step. The titanium dioxide material can also contain an amount of alumina, from aluminum chloride which has been conventionally added as a rutilization aid during the vapor phase oxidation step along with the titanium tetrachloride. Other inorganic oxides formed during the oxidation step may be present as well, to the extent one skilled in the art may wish to incorporate other oxidizable inorganic materials in the oxidation step as has been described or suggested elsewhere for various purposes, for example, particle size control. See, e.g., U.S. Pat. Nos. 3,856,929, 5,201,949, 5,922,120 and 6,562,314. In any event, however, the processing of the titanium dioxide material according to the present invention (and in common with the '433 patent) does not involve the deposition of inorganic oxides on the titanium dioxide material beyond those originally formed with the titanium dioxide in the vapor phase oxidation step and redeposited thereon.

The system used in the wet milling step of the inventive method can be a disk-type agitator, a cage-type agitator, or generally any other type of wet milling system commonly used in the art. The milling media employed can be sand, glass beads, alumina beads, or generally any other commonly used milling media. The individual grains, particles, or beads of the milling media will preferably be more dense than the aqueous media used in forming the titanium dioxide dispersion.

Following the wet milling step, an effective amount of an acid is added to the titanium dioxide dispersion to reduce the pH of the dispersion to a value not exceeding 4.0. The pH of the titanium dioxide dispersion is preferably reduced to a value not exceeding 3.0. The pH of the dispersion is most preferably reduced to a value of about 2.0.

The acid used in the acidification step will preferably be a strong acid such as sulfuric acid, hydrochloric acid and/or nitric acid. Sulfuric acid operates to promote titanium dioxide flocculation and is therefore the acid preferred for use in the pH reduction step.

The pH of the titanium dioxide dispersion is then increased sufficiently to cause the titanium dioxide material to flocculate. Preferably, a sufficient amount of a base is added to the dispersion during this step to increase the pH of the dispersion to a value in the range of from about 5 to about 8. Most preferably, the pH of the dispersion is increased during this step to a value of at least about 6. Examples of bases suitable for use in the inventive method include the hydroxides of the elements of Group I of the Periodic Table. The base used in this step is most preferably sodium hydroxide, potassium hydroxide, or a combination thereof.

The flocculated titanium dioxide is then filtered using a vacuum-type filtration system or a pressure-type filtration system and is washed. At this point, the pH of the washed normally solid or semi-solid titanium dioxide material, in the latter case typically having a titanium dioxide solids content of from about 50 to about 70 percent by weight and a Brookfield viscosity of more than 10,000 cps, is raised to a value greater than about 8.5 via the direct addition of an alkalinizing agent. The alkalinizing agent is preferably added as a solution in water (preferably 25 percent or less in concentration), to provide the aqueous dispersion to be sprayed in the spray drier, typically and preferably having a Brookfield viscosity of less than 1,000 cps.

Suitable alkalinizing agents for the purpose of raising the pH of the washed titanium dioxide intermediate to enable the high solids spray drying of the intermediate comprise hydroxides of monovalent cations including inorganic and organic cations, and monovalent cation salts of phosphoric acid, polyphosphoric acid, boric acid, polyboric acid and polycarboxylic acids, and mixtures thereof. Preferred are hydroxide salts, phosphate salts, polyphosphate salts and polycarboxylate salts of sodium and potassium, and mixtures thereof.

The resulting aqueous dispersion of the titanium dioxide material is then spray dried to produce a dry titanium dioxide pigment powder. The dry product thus produced can be conventionally ground to a desired final particle size distribution using, for example, steam micronization in the presence or absence of additional functional additives as known in the art.

The titanium dioxide pigment powder produced by the process of the present invention is especially suited to use in thermoplastics, especially polyolefin concentrates as are used for producing plastic films and a variety of other articles.

The following examples serve to illustrate specific embodiments of the instant invention without intending to limit or restrict the scope of the invention as disclosed herein. Concentrations and percentages are by weight unless otherwise indicated.

### ILLUSTRATIVE EXAMPLES

### Example 1

Particulate titanium dioxide pigment intermediate obtained from the vapor phase oxidation of titanium tetrachloride, and containing 1.5% lattice alumina, was dispersed in water in the presence of 0.18% by weight based on pigment of sodium hexametaphosphate dispersant, along with a sufficient amount of sodium hydroxide to adjust the pH of the dispersion to a value of 9.5, to achieve an aqueous dispersion solids content of 35% by weight. The resulting titanium dioxide slurry was sand-milled, utilizing a zircon sand-to-pigment weight ratio of 4 to 1, until a volume average particle size was achieved wherein greater than 90% of the particles were smaller than 0.63 microns, as determined utilizing a Microtrac X1 00 Particle Size Analyzer. The slurry was heated to 60° C., acidified to a pH of 2.0 using concentrated sulfuric acid, then allowed to digest at 60° C. for 30 minutes. After this, the pigment slurry pH was adjusted to a value of 6.2 using 20% by weight aqueous sodium hydroxide solution, followed by digestion for an additional 30 minutes at 60° C., with final readjustment of the pH to 6.2, if necessary. The dispersion was subsequently filtered while hot. The resulting filtrate was washed with an amount of water, which had been preheated to 60° C. and pre-adjusted to a pH of 7.0, equal to the weight of recovered pigment. The washed filtrate was subsequently re-dispersed in water, with agitation, in the presence of 0.35% by weight, based on pigment, of trimethylolpropane, and 0.065% by weight, based on pigment, of sodium hydroxide as an alkalinizing agent, to yield a low viscosity 60% solids aqueous titanium dioxide dispersion having a pH of 8.7. The dispersion viscosity was found to be 50 cps, as determined utilizing a Brookfield Viscosimeter (Spindle #5, 100 rpm). The resulting pigment dispersion was then spray dried using an APV Nordic PSD52 Spray Dryer, maintaining a dryer inlet temperature of approximately 280° C., to yield a dry pigment powder. For one thousand grams of pigment, the time required to complete the spray drying step was fifteen minutes. The dry pigment powder was then steam micronized, utilizing a steam to pigment weight ratio of five, with a steam injector pressure set at 146 psi and micronizer ring pressure set at 118 psi, completing the finished pigment preparation.

For the comparative example, the same procedure described above was repeated, but in the absence of the pH adjustment to about 8.5 or greater and the alkalinizing agent. As a result, the titanium dioxide dispersion had to be diluted with water to a solids content of less than 40% in order to lower the viscosity sufficiently to enable pumping to the spray dryer. At 38% solids, the viscosity of the aqueous titanium dioxide dispersion was found to be 1500 cps, as measured on a Brookfield Viscosimeter (Spindle #5, 100 rpm), with a dispersion pH of 7.8. For one thousand grams of pigment, the time required to complete the spray drying step was forty minutes, as opposed to the fifteen experienced with the inventive process.

The finished pigment samples from both procedures were evaluated as formulation ingredients in the synthesis of titanium dioxide/polyethylene concentrates, according to the following procedure:

One hundred and nine and one-half (109.5) grams of a finished pigment described above were mixed with thirty-six and one-half (36.5) grams of Dow 4012 low density polyethylene, a product of The Dow Chemical Company, and 0.05% by weight based on polyethylene of Irganox B-900, a product of Ciba Chemicals, to prepare a 75 percent by weight titanium dioxide-containing polyethylene concentrate via mastication in the mixing bowl of a Brabender Plasticorder Model PL-2000 at 100° C. and a mixing speed of 100 rpm. Instantaneous torque and temperature values were then recorded for a nine minute period to ensure equilibrium mixing conditions had been attained. Equilibrium torque values were determined via averaging the measured instantaneous torque values for a two minute period after equilibrium mixing conditions had been achieved. The resulting pigment concentrate was cooled and ground into pellets. The melt flow index value was determined on the resulting pellet concentrate using ASTM method D1238, procedure B. Maximum extruder processing pressure was determined by extruding 100 grams of the 75% concentrate through a 500 mesh screen filter using a ¾ inch barrel, 25/1 length to diameter extruder attached to the aforementioned Brabender Plasticorder, at an average processing temperature of approximately 190° C., and at 75 rpm, while recording instrument pressure values at the extruder die. Results from evaluations on the inventive and comparative concentrate samples are provided in Table 1.

TABLE 1
Processing Behavior of Titanium Dioxide Containing Polyethylene
Concentrates

| | | Equilibrium | Max. Extruder |
|---|---|---|---|
| | Melt Flow Index | Torque | Processing Pressure |
| | (in g/10 minutes at | (in meter- | through 500 |
| Sample | 190 deg. C.) | grams) | mesh screen (psi) |
| Example 1 | <1 | 1250 | 860 |
| Comp. Ex. 1 | <1 | 1340 | 1020 |

These results demonstrate that dispersions processed in the manner of the prior '433 patent require significantly longer spray drying times than dispersions produced and processed according to the present invention. The pigments resulting from the process of this invention impart improved properties to thermoplastics, especially in the manufacture of thermoplastic concentrates of titanium dioxide, as indicated by the lower equilibrium torque and lower maximum extruder processing pressure values observed.

### Example 2

Particulate titanium dioxide pigment intermediate obtained from the vapor phase oxidation of titanium tetrachloride, and containing 1.5% lattice alumina, was dispersed in water in the presence of 0.18% by weight based on pigment of sodium hexametaphosphate dispersant, along with a sufficient amount of sodium hydroxide to adjust the pH of the dispersion to a value of 9.5, to achieve an aqueous dispersion solids content of 35% by weight. The resulting titanium dioxide slurry was sand-milled, utilizing a zircon sand-to-pigment weight ratio of 4 to 1, until a volume average particle size was achieved wherein more than 90% of the particles were smaller than 0.63 microns, as determined utilizing a Microtrac X1 00 Particle Size Analyzer. The slurry was heated to 60° C., acidified to a pH of 2.0 using concentrated sulfuric acid, then allowed to digest at 60° C. for 30 minutes. After this, the pigment slurry pH was adjusted to a value of 6.2 using 20% by weight aqueous sodium hydroxide solution, followed by digestion for an additional 30 minutes at 60° C., with final readjustment of the pH to 6.2, if necessary. The dispersion was subsequently filtered while hot. The resulting filtrate was washed with an amount of water, which had been preheated to 60° C. and pre-adjusted to a pH of 7.0, equal to the weight of recovered pigment. The washed filtrate was subsequently re-dispersed in water, with agitation, in the presence of 0.35% by weight, based on pigment, of trimethylolpropane, and 0.1% by weight, based on pigment, of sodium hexametaphosphate as an alkalinizing agent, to yield a low viscosity 60% solids aqueous titanium dioxide dispersion with a pH of 8.7. The dispersion viscosity was found to be 50 cps, as determined utilizing a Brookfield Viscosimeter (Spindle #5, 100 rpm). The resulting pigment dispersion was spray dried using an APV Nordic PSD52 Spray Dryer, maintaining a dryer inlet temperature of approximately 280° C., to yield a dry pigment powder. For one thousand grams of pigment, the time required to complete the spray drying step was fifteen minutes. The dry pigment powder was then steam micronized, utilizing a steam to pigment weight ratio of five, with a steam injector pressure set at 146 psi and micronizer ring pressure set at 118 psi, completing the finished pigment preparation.

For the comparative example, the same procedure described above was repeated, but in the absence of the pH adjustment to a pH of 8.5 or more with an alkalinizing agent. As a result, the titanium dioxide dispersion had to be diluted with water to less than 40% solids in order to lower the viscosity sufficiently to enable pumping to the spray dryer. At 38% solids, the viscosity of the aqueous titanium dioxide dispersion was found to be 1500 cps, as measured on a Brookfield Viscosimeter (Spindle #5, 100 rpm), with a dispersion pH of 7.8. For one thousand grams of pigment, the time required to complete the spray drying step was forty minutes.

The finished pigment samples from both procedures were evaluated as formulation ingredients in the synthesis of titanium dioxide/polyethylene concentrates, according to the following procedure:

One hundred and nine and one-half (109.5) grams of a finished pigment described above were mixed with thirty-six and one-half (36.5) grams of Dow 4012 low density polyethylene, a product of The Dow Chemical Co., and 0.05% by weight based on polyethylene of Irganox B-900, a product of Ciba Chemicals, to prepare a 75% by weight titanium dioxide-containing polyethylene concentrate via mastication of the mixture in the mixing bowl of a Brabender Plasticorder Model PL-2000 at 100° C. and a mixing speed of 100 rpm. Instantaneous torque and temperature values were then recorded for a nine minute period to ensure equilibrium mixing conditions had been attained. Equilibrium torque values were determined via averaging the measured instantaneous torque values for a two minute period after equilibrium mixing conditions had been achieved. The resulting pigment concentrate was cooled and ground into pellets. The melt flow index value was determined on the resulting pellet concentrate using ASTM method 01238, procedure B. Maximum extruder processing pressure was determined by extruding 100 grams of the 75% concentrate through a 500 mesh screen filter using a ¾ inch barrel, 25/1 length to diameter extruder attached to the aforementioned Brabender Plasticorder, at an average processing temperature of approximately 190° C. and at 75 rpm, while recording instrument pressure values at the extruder die. Results from these evaluations are provided in Table 2 and confirm the observations made above with respect to Table 1.

TABLE 2
Processing Behavior of Titanium Dioxide Containing Polyethylene
Concentrates

| | | Equilibrium | Max. Extruder |
|---|---|---|---|
| | Melt Flow Index | Torque | Processing Pressure |
| | (in g/10 minutes at | (in meter- | through 500 |
| Sample | 190 deg. C.) | grams) | mesh screen (psi) |
| Example 2 | <1 | 1270 | 870 |
| Comp. Ex. 2 | <1 | 1340 | 1020 |

### Example 3

Particulate titanium dioxide pigment intermediate obtained from the vapor phase oxidation of titanium tetrachloride, and containing 1.5% lattice alumina, was dispersed in water in the presence of 0.18% by weight based on pigment of sodium hexametaphosphate dispersant, along with a sufficient amount of sodium hydroxide to adjust the pH of the dispersion to a value of 9.5, to achieve an aqueous dispersion solids content of 35% by weight. The resulting titanium dioxide slurry was sand-milled, utilizing a zircon sand-to-pigment weight ratio of 4 to 1, until a volume average particle size was achieved wherein more than 90% of the particles were smaller than 0.63 microns, as determined utilizing a Microtrac X1 00 Particle Size Analyzer. The slurry was heated to 60° C., acidified to a pH of 2.0 using concentrated sulfuric acid, then allowed to digest at 60° C. for 30 minutes. After this, the pigment slurry pH was adjusted to a value of 6.2 using 20% by weight aqueous sodium hydroxide solution, followed by digestion for an additional 30 minutes at 60° C., with final readjustment of the pH to 6.2, if necessary. The dispersion was subsequently filtered while hot. The resulting filtrate was washed with an amount of water, which had been preheated to 60° C. and pre-adjusted to a pH of 7.0, equal to the weight of recovered pigment. The washed filtrate was subsequently re-dispersed in water, with agitation, in the presence of 0.35% by weight, based on pigment, of trimethylolpropane, and 0.1% by weight, based on pigment, of a low molecular weight sodium polyacrylate as an alkalinizing agent, to yield a low viscosity 60% solids aqueous titanium dioxide dispersion with a pH of 8.7. The dispersion viscosity was found to be 50 cps, as determined utilizing a Brookfield Viscosimeter (Spindle #5, 100 rpm). The resulting pigment dispersion was spray dried using an APV Nordic PSD52 Spray Dryer, maintaining a dryer inlet temperature of approximately 280° C., to yield a dry pigment powder. For one thousand grams of pigment, the time required to complete the spray drying step was fifteen minutes. The dry pigment powder was then steam micronized, utilizing a steam to pigment weight ratio of five, with a steam injector pressure set at 146 psi and micronizer ring pressure set at 118 psi, completing the finished pigment preparation.

For the comparative example, the same procedure described above was repeated, but in the absence of the final pH adjustment and associated alkalinizing agent. As a result, the titanium dioxide dispersion had to be diluted with water to less than 40% solids in order to lower the viscosity sufficiently to enable pumping to the spray dryer. At 38% solids, the viscosity of the aqueous titanium dioxide dispersion was found to be 1500 cps, as measured on a Brookfield Viscosimeter (Spindle #5, 100 rpm), with a dispersion pH of 7.8. For one thousand grams of pigment, the time required to complete the spray drying step was forty minutes.

The finished pigment samples from both procedures were evaluated as formulation ingredients in the synthesis of titanium dioxide/polyethylene concentrates, according to the following procedure:

One hundred and nine and one-half (109.5) grams of a finished pigment described above were mixed with thirty-six and one-half (36.5) grams of Dow 4012 low density polyethylene, a product of The Dow Chemical Co., and 0.05% by weight based on polyethylene of Irganox B-900, a product of Ciba Chemicals, to prepare a 75% by weight titanium dioxide-containing polyethylene concentrate via mastication of the mixture in the mixing bowl of a Brabender Plasticorder Model PL-2000 at 100° C. and a mixing speed of 100 rpm. Instantaneous torque and temperature values were then recorded for a nine minute period to ensure equilibrium mixing conditions had been attained. Equilibrium torque values were determined via averaging the measured instantaneous torque values for a two minute period after equilibrium mixing conditions had been achieved. The resulting pigment concentrate was cooled and ground into pellets. The melt flow index value was determined on the resulting pellet concentrate using ASTM method 01238, procedure B. Maximum extruder processing pressure was determined by extruding 100 grams of the 75% concentrate through a 500 mesh screen filter using a ¾ inch barrel, 25/1 length to diameter extruder attached to the aforementioned Brabender Plasticorder, at an average processing temperature of approximately 190° C., and at 75 rpm, while recording instrument pressure values at the extruder die. Results from these evaluations are provided in Table 3, and are again consistent with the results of previous examples.

TABLE 3
Processing Behavior of Titanium Dioxide Containing Polyethylene
Concentrates

| | | Equilibrium | Max. Extruder |
|---|---|---|---|
| | Melt Flow Index | Torque | Processing Pressure |
| | (in g/10 minutes: | (in meter- | through 500 |
| Sample | 190 C.) | grams) | mesh screen (psi) |
| Ex. 3 | <1 | 1230 | 860 |
| Comp. Ex,. 3 | <1 | 1340 | 1020 |

From these examples it is readily apparent that use of alkalinizing agents dramatically improves the manufacturing processibility of titanium dioxide pigments having substantially no deposited inorganic oxides.

What is claimed is:

1. A process for producing a spray dried, pigment quality titanium dioxide product, comprising:
a) forming a mixture comprising an agglomerated titanium dioxide material in water, said agglomerated titanium dioxide material being of a character of having been produced by a reaction process including a vapor phase oxidation step and wherein, other than any inorganic oxides formed in said reaction process along with said titanium dioxide material, substantially no inorganic oxides have been deposited on said agglomerated titanium dioxide material;
b) wet milling said mixture;
c) after step b), reducing the pH of said mixture to a value not exceeding 4.0;
d) after step c), adding an effective amount of a base to cause said titanium dioxide material to flocculate whereby the titanium dioxide material may be recovered by vacuum or pressure filtration;
e) after step d), removing said titanium dioxide material from said mixture by vacuum or pressure filtration;
f) after step e), washing said titanium dioxide material;
g) after step f), raising the pH of the washed titanium dioxide material to a value greater than about 8.5 through combination with an alkalinizing agent; and
h) following step g), spray drying a dispersion of the titanium dioxide material to yield the spray-dried, pigment quality titanium dioxide.

2. A process as defined in claim 1, wherein in step c) the pH of the mixture is reduced to a value not exceeding 3.0.

3. A process as defined in claim 2, wherein in step c) the pH of the mixture is reduced to a value of about 2.0.

4. A process as defined in claim 1, wherein in step c) the pH of the mixture is reduced by addition of sulfuric acid.

5. A process as defined in claim 1, wherein in step d) a sufficient amount of a base is added to increase the pH of the mixture to a value in the range of from about 5 to about 8.

6. A process as defined in claim 5, wherein in step d) a sufficient amount of a base is added to increase the pH of the mixture to a value of at least about 6.

7. A process as defined in claim 1, wherein the alkalinizing agent is a solution in water of one or more of the monovalent cation hydroxides and the monovalent cation salts of phosphoric acid, polyphosphoric acid, boric acid, polyboric acid and the polycarboxylic acids.

8. A process as defined in claim 7, wherein the alkalinizing agent is a solution in water of one or more of the hydroxide, phosphate, polyphosphate and polycarboxylate salts of sodium and potassium.

9. A process as defined in claim 1, wherein the combination of the alkalinizing agent and washed titanium dioxide yields a dispersion of titanium dioxide in water having a Brookfield viscosity of less than 1,000 cps.

10. Titanium dioxide as made by a process as defined in claim 1.
